(19) United States
(12) Patent Application Publication
(10) Pub. No.: US 2010/0212006 A1
(43) Pub. Date: Aug. 19, 2010

(54) PEER-TO-PEER TRAFFIC MANAGEMENT BASED ON KEY PRESENCE IN PEER-TO-PEER DATA TRANSFERS

(75) Inventors: Andrew Dolganow, Ottawa (CA); Jason Rusmisel, Ottawa (CA); Steve Morin, Ottawa (CA)

Correspondence Address: Terry W. Kramer, Esq.;Kramer & Amado, P.C., 1725 Duke Street, Suite 240, Alexandria, VA, 22314, US

(73) Assignee: Alcatel-Lucent, Paris (FR)

(21) Appl. No.: 12/371,197

(22) Filed: Feb. 13, 2009

(51) Int. Cl. G06F 21/00

(52) U.S. Cl. 726/14

(57) ABSTRACT

Various exemplary embodiments relate to a method and related network element including one or more of the following: receiving a plurality of packets belonging to an IP flow, the packets received in a network element in the telecommunications network; performing deep packet inspection (DPI) to identify an application protocol associated with the flow; when the application protocol is a peer-to-peer (P2P) protocol, performing DPI to extract a key from one or more of the packets in the flow, the key uniquely identifying a P2P content item; querying a P2P content database using the key, the P2P content database maintaining a mapping between keys and corresponding traffic management actions; and when the key is located in the P2P content database, performing the traffic management action associated with the key in the P2P content database.

### TECHNICAL FIELD

Embodiments disclosed herein relate generally to management of traffic in a telecommunications network and, more particularly, to managing transmission of peer-to-peer content over such a network.

### BACKGROUND

Modern packet-switched networks accommodate a greater number of users and larger amount of traffic than ever before. Many users have sought to harness the increased bandwidth and connectivity to other users to exchange large files, such as multimedia content and software. To this end, users often engage in so-called Peer-to-Peer (P2P) transfers, in which data is exchanged directly between users, rather than between the user and a central server. Such an approach is advantageous, as it allows sharing of massive amounts of information without the need for a central server with the requisite storage and bandwidth.

Unfortunately, P2P transfers can have a significant impact on the Quality of Experience of other users in the network. As an example, a typical BitTorrent transfer may establish fifty or more connections to other peers in the network. Establishing this many connections uses up available bandwidth in transmission lines and burdens the network equipment used to route the packets to the appropriate destination. As the number of users of P2P software has increased, the negative effects on service provider networks have multiplied.

Service providers have been forced to address these problems caused by P2P transfers. Given the significant expenses associated with adding additional equipment, service providers are reluctant to address the P2P problem by simply increasing the capacity of the network. Furthermore, increasing capacity may not be a solution at all, as P2P transfers have the potential to overwhelm any amount of available bandwidth.

As a result, service providers have started to regulate transmission of P2P traffic over their networks. Service providers initially treated all P2P traffic as suspect and gave other transfers preferential treatment over P2P traffic. Such an approach has resulted in significant legal problems for service providers. For example, in the United States, the Federal Communications Commission (FCC) has held that Internet service providers must not discriminate against all P2P traffic, as it violates users' rights to select applications and content of their choice. “Net-neutrality” advocates, those who support fair and equal access to the Internet, have mounted similar legal challenges.

Legal problems aside, treating all P2P traffic as suspect operates on a number of false assumptions. First, such an approach assumes that all P2P transfers are illegitimate, when, in actuality, many content owners use P2P as a cheap, efficient way of allowing users to obtain their content. As an example, many freeware or shareware software developers distribute their software using P2P transfers. Second, the initial approach taken by service providers assumes that P2P transfers have no technical benefits. In fact, P2P transfers allow a massive amount of information to be shared without the need for a large infrastructure of content servers.

Thus, in light of the foregoing, it would be desirable to implement a solution that allows service providers to regulate illegal or otherwise illegitimate P2P transfers, while allowing legitimate P2P transfers to continue as usual. Such a solution would allow service providers to minimize the use of bandwidth for illegal P2P transfers, while preserving net neutrality and harnessing the benefits of P2P for legal transfers. Current implementations fail to enable such an approach, as they provide no way to efficiently distinguish between legitimate and illegitimate content.

For the foregoing reasons and for further reasons that will be apparent to those of skill in the art upon reading and understanding this specification, there is a need for management of P2P transfers based on the underlying content.

### SUMMARY

In light of the present need for management of P2P transfers based on the underlying content, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method and related network element for managing transmission of peer-to-peer content. In particular, a network element may receive a plurality of packets belonging to an IP flow between a source peer and a destination peer. One or more Deep Packet Inspection (DPI) devices may then perform DPI to identify IP flows that use a P2P application protocol and perform further DPI to extract a P2P content key uniquely identifying the P2P content item. Using this key, the DPI device(s) may query a P2P content database to determine an appropriate traffic management action. The network element may then perform the traffic management action based on the knowledge that a P2P transfer involving content of interest is occurring.

It should be apparent that, in this manner, various exemplary embodiments enable content-specific management of P2P transfers over a network. In particular, by accessing a pre-populated database mapping P2P content keys to corresponding traffic management functions, a DPI-equipped network element may quickly and efficiently perform appropriate actions on illegitimate P2P transfers, while allowing legitimate P2P transfers to proceed as normal. Thus, various exemplary embodiments enable a service provider or other entity to preserve bandwidth and maintain the Quality of Experience for all users, while recognizing the legitimate uses of P2P transfers.

### BRIEF DESCRIPTION OF THE DRAWINGS

In order to better understand various exemplary embodiments, reference is made to the accompanying drawings, wherein:

FIG. 1A is a schematic diagram of an exemplary network including a network element configured to perform content identification on a P2P transfer;

FIG. 1B is a schematic diagram of an exemplary network including a network element coupled to a deep packet inspection device configured to perform content identification on a P2P transfer;

FIG. 2 is a schematic diagram of an exemplary data arrangement used to map a P2P content key to a content description and a traffic management action;

FIG. 3 is a flowchart of an exemplary method for performing traffic management on a P2P transfer; and

FIG. 4 is a flowchart of an exemplary method for identifying a key in one or more packets for use in the method of FIG. 3.

### DETAILED DESCRIPTION

Referring now to the drawings, in which like numerals refer to like components or steps, there are disclosed broad aspects of various exemplary embodiments.

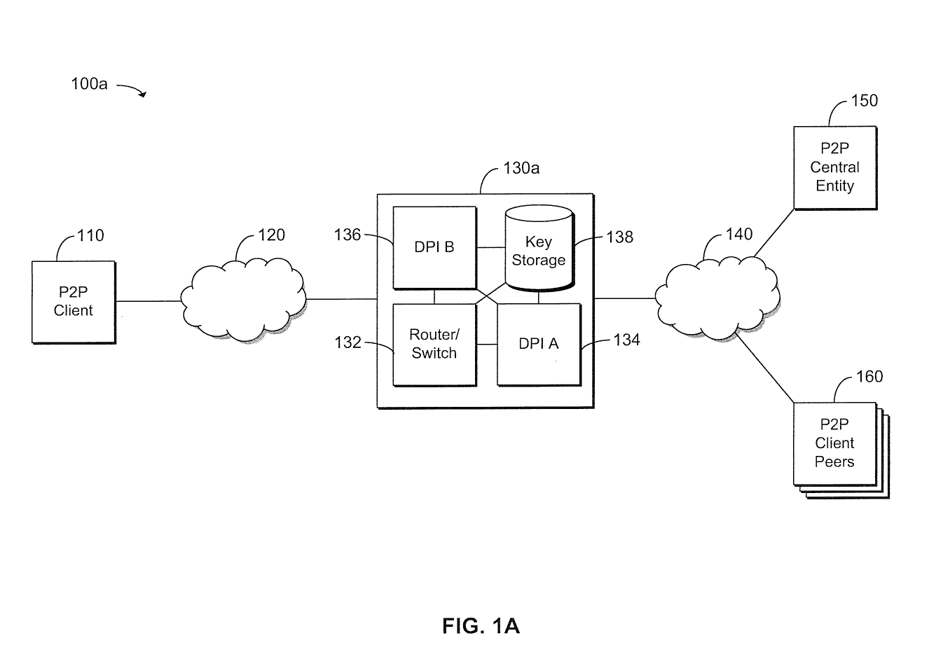

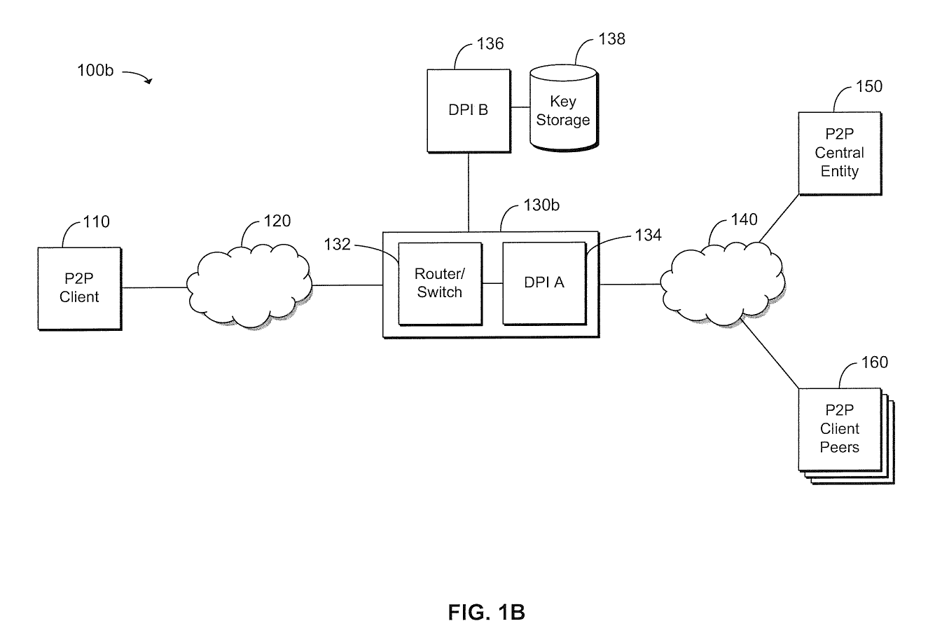

FIG. 1A is a schematic diagram of an exemplary network 100a including a network element 130a configured to perform content identification on a P2P transfer. Network 100a includes P2P client 110, packet-switched network 120, network element 130a, packet-switched network 140, P2P central entity 150, and P2P client peers 160. Network element 130a may include a router or switch 132, deep packet inspection (DPI) device A 134, DPI B 136, and key storage 138.

In various exemplary embodiments, P2P client 110 is a device operated by a user that enables access to network 100a. More specifically, in various exemplary embodiments, P2P client 110 is a cell phone, personal or laptop computer, wireless email device, or any other device that supports peer-to-peer transfers of data. For example, P2P client 110 may be configured to receive and transmit data according to any P2P protocol known to those of skill in the art, including, but not limited to, BitTorrent, Gnutella, and Fast Track.

Packet-switched network 120 provides a connection between P2P client 110 and network element 130a. Network 120 may be any network capable of sending data and requests between P2P client 110 and network element 130a. Accordingly, network 120 may comprise a plurality of routers, switches, bridges, and other components suitable for receiving and forwarding data packets.

Network element 130a is an entity containing components configured to receive, process, and forward packets belonging to an IP flow received from packet-switched network 120. As an example, network element 130a may be owned and/or operated by an Internet Service Provider (ISP) providing services to P2P client 110. Network element 130a may include a router/switch 132, DPI A 134, DPI B 136, and key storage 138.

Router/switch 132 of network element 130a includes hardware, instructions encoded on a machine-readable medium, or a combination thereof, such that router/switch 132 is configured to receive and forward packets. Thus, router/switch 132 may include components to receive a packet from P2P client 110, determine the destination of the packet, and forward the packet toward the appropriate destination. Router/switch 132 may be coupled to DPI A 134 and/or DPI B 136, such that the DPI devices 134, 136 process the packets before they are forwarded toward their destination.

DPI devices 134, 136 include hardware, instructions encoded on a machine-readable medium, or a combination thereof, such that DPI devices 134, 136 are configured to examine data packets received by router/switch 132 to identify information associated with the packets. In particular, DPI devices 134, 136 may examine any combination of information in layers 2 through 7 of the Open Systems Interconnection (OSI) model in order to identify an application protocol and P2P key associated with a data flow.

It should be apparent that a number of arrangements of DPI devices 134, 136 may be used. For example, DPI A 134 and/or DPI B 136 may be standalone devices or may be integrated into router/switch 132. Other suitable arrangements will be apparent to those of skill in the art.

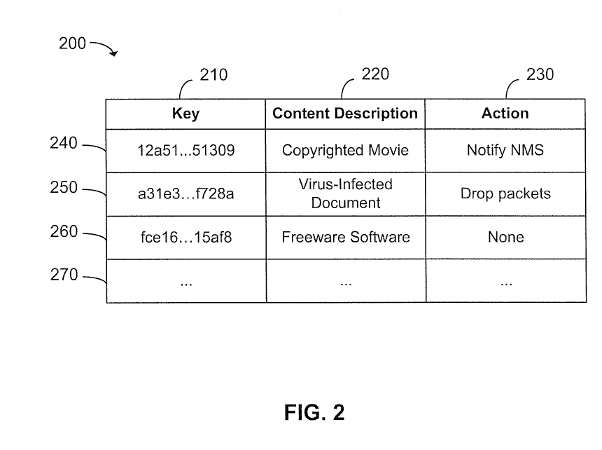

Key storage 138 may be a machine-readable medium storing a predetermined mapping between P2P keys and a corresponding traffic management action. Key storage 138 may optionally store a description of the content to indicate, for example, whether the P2P key relates to a video file, audio file, application, or the like. An exemplary data arrangement used for key storage 138 is described in further detail below with reference to FIG. 2. The information in key storage 138 may be populated in accordance with Co-Pending Application Serial No. [To Be Determined], Attorney Docket Number ALC 3460, “Apparatus and Method for Generating a Database that Maps Metadata to P2P Content” to Dolganow et al., incorporated by reference herein.

Packet-switched network 140 provides a connection between network element 130a, P2P central entity 150, and P2P client peers 160. Network 140 may be any network capable of sending data and requests between network element 130a, P2P central entity 150, and P2P client peers 160. Accordingly, as with network 120, network 140 may comprise a plurality of routers, switches, bridges, and other components suitable for receiving and forwarding data packets.

P2P central entity 150 may be a system configured to respond to queries from P2P client 110 and P2P client peers 160. In particular, P2P central entity 150 may store a database of information maintained within a particular P2P network, such that a user may search P2P central entity 150 to determine the location of desired content based on the file key. As an example, P2P central entity 150 may be a BitTorrent tracker configured to receive a request including an info_hash from P2P client 110 and respond with a list containing location information of P2P client peers 160 that maintain the content.

P2P client peers 160 may be devices operated by users that support P2P transfers of data to P2P client 110. Thus, as with P2P client 110, P2P client peers 160 may be cell phones, personal or laptop computers, wireless email devices, or any other devices that support peer-to-peer transfers of data. For example, P2P client peers 160 may be configured to receive and transmit data according to any P2P protocol known to those of skill in the art, provided that the peers 160 communicate using the same protocol as P2P client 110.

P2P client peers 160 may be configured to receive a request for data from P2P client 110, then transmit the data to P2P client 110 over network 100a. As an example, when the P2P protocol is BitTorrent, P2P client 110 and one or more of P2P client peers 160 may engage in a handshake, in which client 110 sends a handshake message including the info_hash corresponding to the requested content. Assuming the client peer 160 has the corresponding content, the peer 160 returns a handshake message including the info_hash. The client peer 160 may then begin transmission of the data corresponding to the requested info_hash. As described in further detail below, the actions performed by network element 130a may be based on the exchange of a handshake or similar negotiation message, or based on the actual transmission of the P2P content. In particular, when P2P client 110 and one or more of the P2P client peers 160 exchange unencrypted control messages and/or data, network element 130a may detect a key in the exchange and take appropriate action.

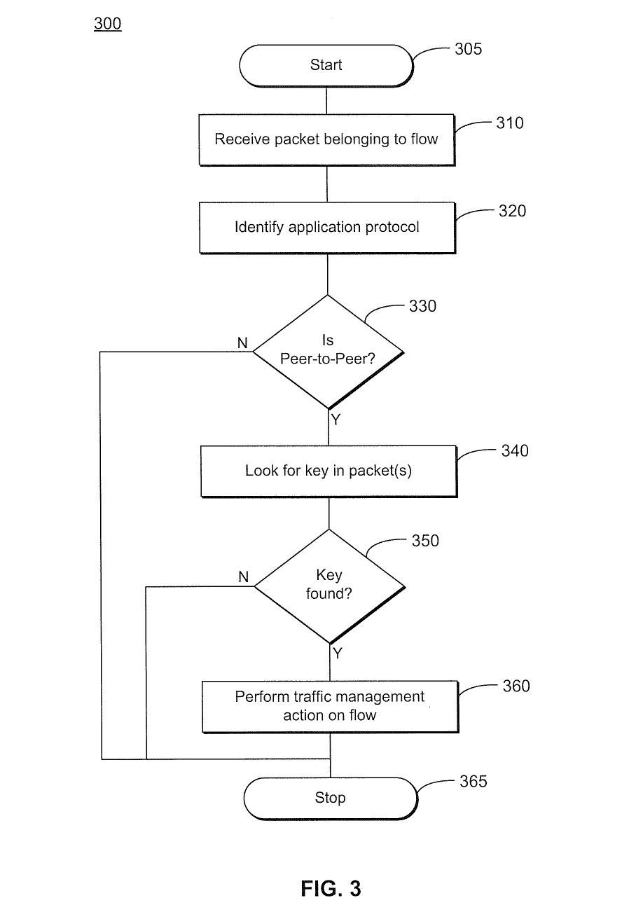

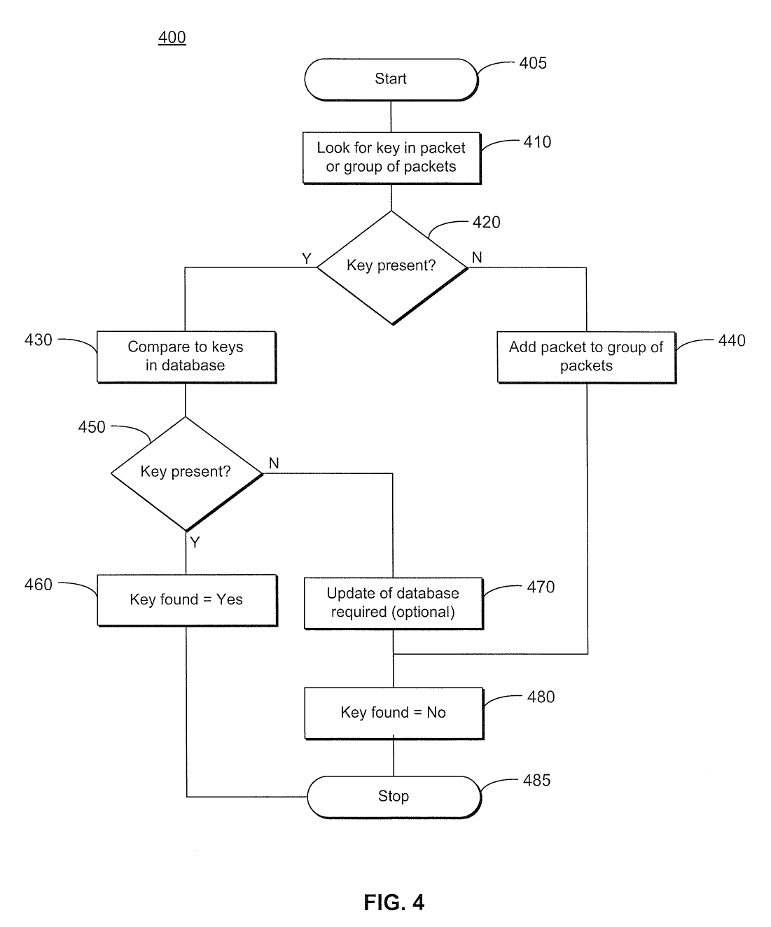

Having described the components of network 100a, a brief summary of the operation of network 100a will be provided. It should be apparent that the following description is intended to provide an overview of the operation of network 100a and network element 130a and is therefore a simplification in some respects. The detailed operation of network element 130a will be described in further detail below with reference to FIGS. 3 and 4. Furthermore, although the functionality is described as divided between DPI A 134 and DPI B 136, it should be apparent that all functionality may be performed on a single DPI device.

In operation, according to the various exemplary embodiments, DPI A 134 may be configured to use deep packet inspection to identify an application protocol associated with an IP flow received by router/switch 132, then determine whether the application protocol is a P2P protocol. DPI A 134 may accomplish this by, for example, performing pattern-based, statistical, or behavioral analysis of the packets being sent and/or received by a given system and thereby classifying an IP flow as “Peer-to-Peer.” When the IP flow uses a P2P protocol, DPI A 134 may transmit the packets belonging to the flow to DPI B 136 for further processing. Thus, DPI A 134 may perform initial filtering of traffic that DPI B 136 is to process.

An IP flow may be any IP flow between P2P client 110 and P2P central entity 150 or P2P client 110 and a P2P client peer 160, as identifiable by IP 5-tuple information, which includes the source IP address, source port, destination IP address, destination port, and protocol of the IP flow. This IP flow may be further tunneled inside another networking layer, such as IP, Ethernet, ATM, and the like.

Upon receipt of the packets from DPI A 134, DPI B 136 may perform deep packet inspection to extract a key from one or more packets in the unencrypted flow between a source peer and a destination peer, the key uniquely identifying the content associated with the P2P transfer. As an example, the BitTorrent protocol utilizes a field known as info_hash, which is a 20-byte hash of the info field. The info field, in turn, describes the file(s) contained in the torrent and includes, among other fields, the name of the file(s), the length of the file(s) in bytes, and an optional 32-character MD5 sum of the file. As described above, handshakes and data exchanges between P2P client 110 and one or more of P2P client peers 160 include the info_hash.

According to the various exemplary embodiments, DPI B 136 may extract the key uniquely identifying the content associated with the P2P transfer, then utilize the extracted key to select an appropriate traffic management function. In particular, DPI B 136 may access key storage 138 and determine the corresponding traffic management function maintained in key storage 138. After the database lookup, DPI B 136 may notify network element 130a of the retrieved traffic management action. Network element 130a may then, in turn, take appropriate action on the IP flow, a class of traffic from P2P client 110, or all transfers from P2P client 110.

It should be apparent from this description of network element 130a that the implementation of a lookup of a key and a corresponding traffic management action allows management of P2P data flows based on the underlying content, without the need to download and identify the content during the exchange between the peers. In particular, network element 130a may take an action specific to the content of the transfer using DPI and a look up to a pre-populated database.

FIG. 1B is a schematic diagram of an exemplary network 100b including a network element 130b coupled to a deep packet inspection device 136 configured to perform content identification on a P2P transfer. As with network 100a, network 100b includes P2P client 110, packet-switched networks 120, 140, P2P central entity 150, and P2P client peers 160. Unlike network 100a, network element 130b of network 100b includes only router/switch 132 and DPI A 134. DPI B 136 is a standalone device connected to network element 130b.

In operation, DPI A 134 and DPI B 136 perform functionality described above in connection with FIG. 1. In order to ensure that DPI B 136 receives the information required to identify the key in the P2P data exchange, however, DPI A 134 transmits the information to DPI B 136. This transmission may be accomplished by mirroring (i.e., duplicating) the packets in the IP flow that contain the key from DPI A 134 to DPI B 136. Alternatively, this transmission may be accomplished by redirecting (i.e., rerouting) the packets in the IP flow that contain the key from DPI A 134 to DPI B 136. As another alternative, DPI A 134 may build and send a message including the required information to DPI B 136. Details regarding techniques for transmitting the required information from DPI A 134 to DPI B 136, while minimizing the amount of data transmitted are described in further detail in Co-Pending application Ser. No. [To Be Determined], Attorney Docket Number ALC 3459, “Optimized Mirror for P2P Identification” to Dolganow et al., incorporated by reference herein.

FIG. 2 is a schematic diagram of an exemplary data arrangement 200 used to map a P2P content key 210 to a content description 220 and a traffic management action 230. Data arrangement 200 may be, for example, a table in a database stored in key storage 138. Alternatively, data arrangement 200 could be a series of linked lists, an array, or a similar data structure. Thus, it should be apparent that data arrangement 200 is an abstraction of the underlying data; any data structure suitable for storage of this data may be used.

Data arrangement 200 may include three sets of data: key field 210, content description field 220, and traffic management action field 230. Key field 210 may indicate the value of a key used to uniquely identify a P2P content item. Optional content description field 220 may indicate a file type, title, or any other information relevant to describing the underlying content item. It should be apparent that content description field 220 is optional, as there is no longer a need for the content description 220 once the key has been identified as interest and an action has been associated with the key. Traffic management action field 230 may indicate an action to be performed by network element upon detecting a transmission between two P2P clients including the key.

As an example, data 240 indicates that the key is “12a51 . . . 51309,” that the content corresponding to the key is a copyrighted movie, and that the network element should notify the network management system upon detection of a transmission including the key. Data 250 indicates that the key is “a31e3 . . . f728a,” that the content corresponding to the key is a virus-infected document, and that the network element should drop any packets transmitted with this key. Finally, data 260 indicates that the key is “fce16 . . . 15af8,” that the content corresponding to the key is freeware software, and that the network element should allow the transfer to proceed as normal upon detection of the key. Data arrangement 200 may include numerous other data entries 270.

FIG. 3 is a flowchart of an exemplary method 300 for performing traffic management on a P2P transfer. Exemplary method 300 may be performed by the components of network 100a, 100b to manage, for example, P2P transmissions between a P2P client 110 and a P2P client peer 160. In the description that follows, the steps are described as performed by one or more specific components of network 100a, 100b. As will be apparent to those of skill in the art, the steps may be distributed differently among the components of network 100a, 100b. As an example, all DPI processing may be performed by a single DPI device.

Exemplary method 300 starts in step 305 and proceeds to step 310, where network element 130a, 130b receives a plurality of packets belonging to an IP flow. As an example, network element 130a, 130b may receive a number of packets belonging to an IP flow between a P2P client 110 and a P2P client peer 160. The packets in the IP flow could be related to, for example, a control exchange used to establish a connection between a source peer and a destination peer. Alternatively, the packets could be packets containing the P2P content exchanged between the source and destination.

Exemplary method 300 then proceeds to step 320, where DPI A 134 identifies an application protocol associated with the IP flow using one or more packets belonging to the flow. In particular, as will be apparent to those of skill in the art, DPI A 134 may analyze any combination of information contained in Layers 2 through 7 of the packets to extract an application protocol associated with the flow.

After DPI A 134 identifies the application protocol associated with the flow, exemplary method 300 proceeds to decision step 330, where DPI A 134 determines whether the identified application protocol is a P2P protocol. As an example, DPI A 134 may determine whether the identified protocol belongs to a stored list of P2P protocols, including, for example, BitTorrent, FastTrack, and Gnutella. When, in decision step 330, DPI A 134 determines that the application protocol associated with the IP flow is not a P2P protocol, exemplary method 300 proceeds to step 365, where exemplary method 300 stops. Alternatively, when, in decision step 330, DPI A 134 determines that the application protocol associated with the IP flow is a P2P protocol, exemplary method proceeds to step 340.

In step 340, after a determination that the IP flow protocol is P2P, DPI B 136 looks for a key identifying the P2P content transmitted in the flow. For example, when the protocol is BitTorrent, DPI B 136 performs deep packet inspection to determine whether an info_hash field is present in the packets of the flow.

It should be apparent that, as described in further detail below with reference to FIG. 4, DPI B 136 may need to inspect multiple packets in order to extract the key from the IP flow. Thus, DPI B 136 may cache packets, such that multiple packets are used in extracting a key. Furthermore, in some circumstances, DPI B 136 may need to wait until the IP flow is complete before it is able to extract the key.

In implementations in which DPI B 136 receives packets from DPI A 134 before the IP flow is positively identified as P2P, DPI B 136 may remove packets from the cache upon identification of the IP flow as non-P2P. As an example, DPI B 136 may trigger removal of these packets from the cache upon receipt of an indication from DPI A 134 that the IP flow is not P2P.

Exemplary method 300 then proceeds to decision step 350, where DPI B 136 determines whether a key identifying the content was located in the packets of the IP flow. When, in decision step 350, DPI B 136 determines that a key was not found exemplary method 300 proceeds to step 365, where exemplary method 300 stops. Alternatively, when, in decision step 350, DPI B 136 determines that a key was found, exemplary method 300 proceeds to step 360.

In step 360, DPI B 136 performs a traffic management action on the IP flow based on a query to key storage 138. In particular, DPI B 136 may query key storage 138 using the key found in step 340 to retrieve the corresponding traffic management action to be performed on the IP flow. Network element 130a, 130b, or one of the components therein, may then perform the retrieved traffic management function.

As will be apparent to those of ordinary skill in the art, any appropriate traffic management action may be performed in response to detection of a P2P content key in the IP flow. As an example, network element 130a, 130b may transmit a notification to a network management entity indicating that a transfer involving the P2P content item corresponding to the key has occurred. The network management entity may then take appropriate action, such as defining a further action to take place and notifying the copyright owner. As a number of other examples, network element 130a, 130b may drop all packets belonging to the flow, redirect packets belonging to the flow along a different route, modify bandwidth available to the flow, and change a Quality of Service (QoS) marking associated with packets belonging to the flow. In addition to performing these actions on the flow itself, network element 130a may perform these actions on all of the client's traffic or a class of the client's traffic (e.g. all P2P transfers).

After performing the traffic management action on the flow, exemplary method 300 proceeds to step 365, where exemplary method 300 stops.

FIG. 4 is a flowchart of an exemplary method 400 for identifying P2P content key in one or more packets belonging to a P2P flow. In particular, exemplary method 400 may correspond to the processing performed by DPI B 136 or another device in connection with step 340 of FIG. 3.

Exemplary method 400 starts in step 405 and proceeds to step 410, where DPI B 136 looks for a key in a packet or group of packets in the IP flow utilizing deep packet inspection. The implementation of this deep packet inspection procedure will be apparent to those of ordinary skill in the art based on knowledge of the corresponding P2P protocol. As an example, DPI B 136 may inspect the info_hash field contained in the handshake message exchanged when establishing a connection between P2P client 110 and a P2P client peer 160. Analogous keys in other P2P protocols will be apparent to those of skill in the art.

After DPI B 136 looks for a key, exemplary method 400 proceeds to decision step 420, where DPI B 136 determines whether a key was found. When it is determined that a key was not present in the packet or group of packets, exemplary method 400 proceeds to step 440, where DPI B 136 adds the packet to a group of packets. Thus, when another packet in the IP flow arrives, this packet may be considered when looking for a key in step 410. Exemplary method 400 then proceeds to step 480.

Alternatively, when DPI B 136 determines in decision step 420 that a key is present in the packets of the IP flow, exemplary method 400 proceeds to step 430, where the key is compared to the records in key storage 138. Exemplary method 400 then proceeds to decision step 450, where DPI B 136 determines whether the key is present in key storage 138. When it is determined that the key is present, exemplary method 400 proceeds to step 460, where DPI B 136 generates an indication that the key was found, which may be used to trigger an appropriate traffic management action in the processing of FIG. 3.

In contrast, when, DPI B 136 determines in decision step 450 that the key is not present in key storage 138, exemplary method 400 proceeds to optional step 470. In particular, when the intent of key storage 138 is to maintain a complete record of all P2P content keys recognized by DPI B 136, DPI B 136 may store a marking in key storage 138 indicating that an update is required. This marking may indicate to the entity managing storage 138 that a content identification should be performed and a corresponding action specified. Alternatively, DPI B 136 may indicate to storage 138 that storage 138 should immediately update the content database by initiating a download of the full content item corresponding to the key and associating a traffic management action with the key.

Exemplary method 400 then proceeds to step 480, where DPI B 136 generates an indication that the key was not found. Finally, exemplary method 400 proceeds to step 485, where exemplary method 400 stops.

An example of the operation of the various exemplary embodiments will now be described with reference to FIGS. 1A, 1B, 2, 3, and 4. It should be apparent that the following example is provided for purposes of explanation and should not be interpreted to limit the scope of the invention.

Suppose P2P client 110 seeks to download a document of interest and queries a P2P indexing service to determine whether a file is available. This indexing service could be, for example, a web server maintaining a directory of available content and corresponding keys. The P2P indexing service may return a torrent file including the key. As an example, the returned P2P content key may be “a31e3 . . . f728a.”

P2P client 110 may now query P2P central entity 150, such as a torrent tracker, using the P2P content key to obtain one or more locations of the document. P2P central entity 150 uses the content key, “a31e3 . . . f728a,” to return a list of P2P client peers 160 that maintain the file. In response, P2P client 110 may connect to one or more of the P2P client peers 160 to initiate a download of the file, including the key in a request to initiate a transfer sent to the peer 160. In particular, this connection may be initiated based on an exchange of handshake messages between P2P client 110 and the selected P2P client peer 160.

Because all packets involved in the control and data exchange between P2P client 110 and P2P client peer 160 go through network element 130a, 130b, the DPI devices 136, 138 may perform deep packet inspection to determine that the IP flow relates to a P2P transfer involving the content corresponding to key, “a31e3 . . . f728a,” assuming that the exchange is unencrypted. Pre-populated key storage 138, shown in FIG. 2, indicates that “a31e3 . . . f728a” is a virus-infected document and that the network element 130a, 130b should drop all packets involved in the transfer. Accordingly, after querying key storage 138, network element 130a, 130b may drop any packets transmitted between P2P client 110 and P2P client peer 160 that belong to the IP flow.

According to the foregoing, various exemplary embodiments enable content-specific management of unencrypted P2P transfers over a network between a client and corresponding peers. In particular, by accessing a pre-populated database mapping P2P content keys to corresponding traffic management functions, a DPI-equipped network element may quickly and efficiently perform appropriate actions on illegitimate P2P transfers, while allowing legitimate P2P transfers to proceed as normal. Thus, the various exemplary embodiments enable a service provider or other entity to preserve bandwidth and maintain the Quality of Experience for all users, while recognizing the legitimate uses of P2P transfers.

Related techniques for monitoring and managing P2P transfers are detailed in the following co-pending applications, each of which is incorporated by reference herein: application Ser. No. [To Be Determined], Attorney Docket Number ALC 3462, “Peer-to-Peer Traffic Management Based on Key Presence in Peer-to-Peer Data Transfers” to Dolganow et al.; and application Ser. No. [To Be Determined], Attorney Docket Number ALC 3466, “Inline Key-Based Peer-to-Peer Processing” to Dolganow et al.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a network node (e.g. router or switch). Thus, a machine-readable storage medium may include read-only memory (ROM), random-access memory (RAM), magnetic disk storage media, optical storage media, flash-memory devices, and similar storage media.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be implemented while remaining within the spirit and scope of the invention. Accordingly, the foregoing disclosure, description, and figures are for illustrative purposes only and do not in any way limit the invention, which is defined only by the claims.

What is claimed is:

1. A method for managing transmission of peer-to-peer content over a telecommunications network, the method comprising:
receiving a plurality of packets belonging to a IP flow between a source peer and a destination peer, the packets received in a network element in the network;
performing deep packet inspection (DPI) to identify an application protocol associated with the flow;
when the application protocol is a peer-to-peer (P2P) protocol, performing DPI to extract a key from one or more of the packets in the flow, the key uniquely identifying a P2P content item associated with the flow;
querying a P2P content database using the key, the P2P content database maintaining a mapping between keys and corresponding traffic management actions; and
when the key is located in the P2P content database, performing the traffic management action associated with the key in the P2P content database.

2. The method for managing transmission of peer-to-peer content according to claim 1, wherein the P2P protocol is BitTorrent and the key is an info_hash parameter that uniquely identifies the P2P content item.

3. The method for managing transmission of peer-to-peer content according to claim 1, wherein the one or more packets used to extract the key are exchanged when establishing a connection between the source peer and the destination peer in the network.

4. The method for managing transmission of peer-to-peer content according to claim 1, wherein the P2P content database further stores a description of the P2P content associated with each key.

5. The method for managing transmission of peer-to-peer content according to claim 1, further comprising:
when the key is not located in the P2P content database, storing a marking in the P2P content database, the marking indicating that the P2P content database must be updated to associate a traffic management action with the key.

6. The method for managing transmission of peer-to-peer content according to claim 1, further comprising:
when the key is not located in the P2P content database, initiating download of the P2P content item corresponding to the key; and
updating the P2P content database to associate a traffic management action with the key.

7. The method for managing transmission of peer-to-peer content according to claim 1, wherein the traffic management action comprises notifying a network management entity that a transfer involving the P2P content item has occurred.

8. The method for managing transmission of peer-to-peer content according to claim 1, wherein the traffic management action comprises at least one of:
dropping packets belonging to the flow,
redirecting packets belonging to the flow,
modifying bandwidth available to the flow, and
changing a Quality of Service for packets belonging to the flow.

9. A system for managing transmission of peer-to-peer content over a telecommunications network, the system comprising:
a network element configured to receive a plurality of packets belonging to an IP flow between a source peer and a destination peer;
a P2P content database maintaining a mapping between peer-to-peer (P2P) content keys and corresponding traffic management actions, each key uniquely identifying a P2P content item; and
at least one deep packet inspection (DPI) device configured to:
identify an application protocol associated with the flow received by the network element,
determine whether the application protocol is a peer-to-peer (P2P) protocol,
when the application protocol is a P2P protocol, perform DPI to extract a key from one or more packets in the flow, the key uniquely identifying a P2P content item associated with the flow,
query the P2P content database using the key, and
when the key is located in the P2P content database, notify the network element to perform the traffic management action associated with the key in the P2P content database.

10. The system for managing transmission of peer-to-peer content according to claim 9, wherein the P2P protocol is BitTorrent and the key is an info_hash parameter that identifies the P2P content item.

11. The system for managing transmission of peer-to-peer content according to claim 9, wherein the one or more packets used to extract the key are exchanged when establishing a connection between the source peer and the destination peer in the network.

12. The system for managing transmission of peer-to-peer content according to claim 9, wherein the P2P content database further stores a description of the P2P content associated with each key.

13. The system for managing transmission of peer-to-peer content according to claim 9, wherein the at least one DPI device is further configured to:
when the key is not located in the P2P content database, store a marking in the P2P content database, the marking indicating that the P2P content database must be updated to associate a traffic management action with the key.

14. The system for managing transmission of peer-to-peer content according to claim 9, wherein the traffic management action comprises notifying a network management entity that a transfer involving the P2P content item has occurred.

15. The system for managing transmission of peer-to-peer content according to claim 9, wherein the traffic management action comprises at least one of:
dropping packets belonging to the flow,
redirecting packets belonging to the flow,
modifying bandwidth available to the flow, and
changing a Quality of Service for packets belonging to the flow.

16. The system for managing transmission of peer-to-peer content according to claim 9, wherein the at least one DPI device comprises a first DPI device and a second DPI device.

17. The system for managing transmission of peer-to-peer content according to claim 16, wherein the first DPI device and the second DPI device are located in the network element.

18. The system for managing transmission of peer-to-peer content according to claim 16, wherein the first DPI device is located in the network element and the second DPI device is a standalone device connected to the network element.

19. The system for managing transmission of peer-to-peer content according to claim 18, wherein the first DPI device mirrors the one or more packets in the flow containing the key to the second DPI device.

20. The system for managing transmission of peer-to-peer content according to claim 18, wherein the first DPI device redirects the one or more packets in the flow containing the key to the second DPI device.
